(19) United States
(12) Patent Application Publication
(10) Pub. No.: US 2026/0086842 A1
(43) Pub. Date: Mar. 26, 2026

(54) CLONE CREATION METHOD AND STORAGE SYSTEM

(71) Applicant: Hitachi Vantara, Ltd., Kanagawa-ken (JP)

(72) Inventors: Akiyoshi TSUCHIYA, Tokyo (JP); Akira DEGUCHI, Tokyo (JP)

(21) Appl. No.: 19/075,036

(22) Filed: Mar. 10, 2025

(30) Foreign Application Priority Data
Sep. 20, 2024 (JP) 2024-163951

(51) Int. Cl. G06F 9/455

(52) U.S. Cl. CPC G06F 9/45558; G06F 2009/45562; G06F 2009/45583

(57) ABSTRACT

A storage system including storage nodes provides a volume for a server, and creates, in the storage node, a volume entity that is created in association with a storage area of a drive and stores data input to the volume. When a creation request for a clone volume of the volume is received, the storage system creates, in any of the storage nodes, a clone volume entity that is associated with the clone volume and is for accessing data in a storage device related to the volume entity. A plurality of volume entities are created in a plurality of storage nodes, and the data is stored in storage areas of different drives. When a creation request for the clone volume is received, the storage system selects a storage node, which creates the clone volume entity, and a volume entity related to an access destination of the clone volume entity.

### CROSS-REFERENCE TO PRIOR APPLICATION

This application relates to and claims the benefit of priority from Japanese Patent Application number 2024-163951, filed on Sep. 20, 2024 the entire disclosure of which is incorporated herein by reference.

### BACKGROUND OF THE INVENTION

### 1. Field of the Invention

The present invention relates to a clone creation method and a storage system.

### 2. Description of Related Art

In the operation of a virtual machine, it is common to create a large number of replication environments of a virtual environment for running the virtual machine by creating a clone volume. In a case of applying a scale-out storage to such a virtual environment, when a large number of clone volumes are created from one volume, it is necessary to move the clone volumes between nodes to achieve load distribution due to restrictions on the load and capacity of the nodes.

For example, PTL 1 discloses a related art in which a volume is moved between nodes so as to equalize the load according to an input and output (IO) load of each volume. By using this related art, when a scale-out storage is applied to a virtual environment for running a virtual machine, a created clone volume can be moved between nodes to achieve load distribution.

### CITATION LIST

### Patent Literature

PTL 1: U.S. Pat. No. 10,979,505

PTL 2: U.S. Pat. No. 8,943,286

PTL 3: U.S. Pat. No. 7,152,079

PTL 4: U.S. Pat. No. 10,353,592

### SUMMARY OF THE INVENTION

However, in the related art described above, since a large number of clone volumes are moved between nodes, a network load may increase, and when a resource shortage of the nodes occurs, deployment of a virtual machine may be delayed until movement of the clone volumes between nodes is completed. Such problem also occurs in the operation of a container-type server.

The invention has been made in view of the above problems, and an object thereof is to reduce a network load in moving a clone volume between nodes and to restrict a delay in completion of the movement of the clone volume.

In order to achieve the above object, an aspect of the invention is a clone creation method for a storage system including a plurality of storage nodes each including a processor, a memory, and a drive, the clone creation method including processors of the plurality of storage nodes performing processing of: providing a volume for a server; creating, in a storage node, a volume entity that is created corresponding to a storage area of the drive and stores data input to the volume; when a creation request for a clone volume of the volume is received, creating, in any storage node, a clone volume entity that is associated with the clone volume and is for accessing data in a storage device related to the volume entity; creating a plurality of volume entities in a plurality of storage nodes, and storing the data in storage areas of different drives; and selecting a storage node, which creates the clone volume entity, and a volume entity related to an access destination of the clone volume entity when a creation request for the clone volume is received.

According to the invention, for example, it is possible to reduce a network load in moving a clone volume between nodes and restrict a delay in completion of the movement of the clone volume.

### BRIEF DESCRIPTION OF THE DRAWINGS

FIG. 1A is a diagram illustrating a processing image of clone creation processing.

FIG. 1B is a diagram illustrating a processing image of clone creation processing.

FIG. 1C is a diagram illustrating a processing image of clone creation processing.

FIG. 2 is a diagram illustrating an outline of a first embodiment.

FIG. 3 is a diagram illustrating a configuration of an information processing system S according to the first embodiment.

FIG. 4 is a diagram illustrating a configuration of a memory provided in a storage node according to the first embodiment.

FIG. 5 illustrates a configuration of a storage node management table according to the first embodiment.

FIG. 6 illustrates a configuration of a volume management table according to the first embodiment.

FIG. 7 illustrates a configuration of a volume entity management table according to the first embodiment.

FIG. 8 is a sequence diagram illustrating volume entity replication processing according to the first embodiment.

FIG. 9 is a sequence diagram illustrating clone processing according to the first embodiment.

FIG. 10 illustrates a volume management table according to a second embodiment.

FIG. 11 is a flowchart illustrating volume entity replication processing according to the second embodiment. FIG. 12 is a sequence diagram illustrating clone processing according to the second embodiment.

FIG. 13 is a diagram illustrating an outline of a third embodiment.

FIG. 14 illustrates a configuration of a VM management table according to the third embodiment.

FIG. 15 illustrates a configuration of a virtual volume management table according to the third embodiment.

FIG. 16 is a sequence diagram illustrating volume entity replication processing according to the third embodiment.

FIG. 17 is a diagram illustrating an outline of a fourth embodiment.

FIG. 18 illustrates a configuration of a virtual volume management table according to the fourth embodiment.

FIG. 19 is a sequence diagram illustrating volume entity replication processing according to the fourth embodiment.

FIG. 20 is a sequence diagram illustrating virtual volume clone processing according to the fourth embodiment.

FIG. 21 is a diagram illustrating an outline of a fifth embodiment.

FIG. 22 illustrates a configuration of a storage management table according to the fifth embodiment.

FIG. 23 is a diagram illustrating an outline of a sixth embodiment.

FIG. 24 is a graph illustrating an outline of a seventh embodiment.

FIG. 25 is a flowchart illustrating volume entity replication processing according to the seventh embodiment.

FIG. 26 is a diagram illustrating an outline of an eighth embodiment.

### DESCRIPTION OF EMBODIMENTS

In the following description, an “interface device” may be one or more communication interface devices. The one or more communication interface devices may be one or more communication interface devices of the same type (for example, one or more network interface cards (NIC)) or two or more communication interface devices of different types (for example, an NIC and a host bus adapter (HBA)).

In the following description, a “memory” is one or more memory devices serving as an example of one or more storage devices and may be typically a main storage device. At least one memory device in the memory may be a volatile memory device or a non-volatile memory device.

In the following description, a “drive” is a persistent storage device. The persistent storage device may typically be a non-volatile storage device (for example, an auxiliary storage device), and specifically may be, for example, a hard disk drive (HDD), a solid state drive (SSD), or a non-volatile memory express (NVMe) drive.

In the following description, a “processor” may be one or more processor devices. At least one processor device may typically be a micro-processor device such as a central processing unit (CPU), and may also be another type of processor device such as a graphics processing unit (GPU). At least one processor device may be a single core or a multi-core. At least one processor device may be a processor core. At least one processor device may be a processor device in a broad sense, such as a hardware circuit (for example, a field-programmable gate array (FPGA), a complex programmable logic device (CPLD), or an application specific integrated circuit (ASIC)) that performs a part or all of processing.

In the following description, information from which an output is obtained in response to an input may be described using an expression such as “xxx table”. However, the information may be data of any structure (for example, may be structured data or unstructured data), or may be a learning model represented by a neural network, a genetic algorithm, or a random forest that generates an output with respect to an input. Therefore, the “xxx table” can be referred to as “xxx information”. In the following description, a configuration of each table is an example. One table may be divided into two or more tables, or all or some of two or more tables may be one table.

In the following description, processing may be described using a “program” as the subject. However, the program is executed by a processor to perform predetermined processing while appropriately using a storage device and/or an interface device. Therefore, the subject of the processing may be a processor (or a device such as a controller including the processor). The program may be installed on a device such as a computer from a program source. The program source may be, for example, a program distribution server or a computer-readable (for example, non-transitory) recording medium. In addition, in the following description, two or more programs may be implemented as one program, or one program may be implemented as two or more programs.

In the following description of the embodiments, differences from preceding embodiments will be mainly described, and a description of overlapping portions with the preceding embodiments will be omitted.

### First Embodiment

### Outline of Clone Creation Processing

Prior to the description of the first embodiment, an outline of clone creation processing will be described.

### Configuration of Storage 100Z

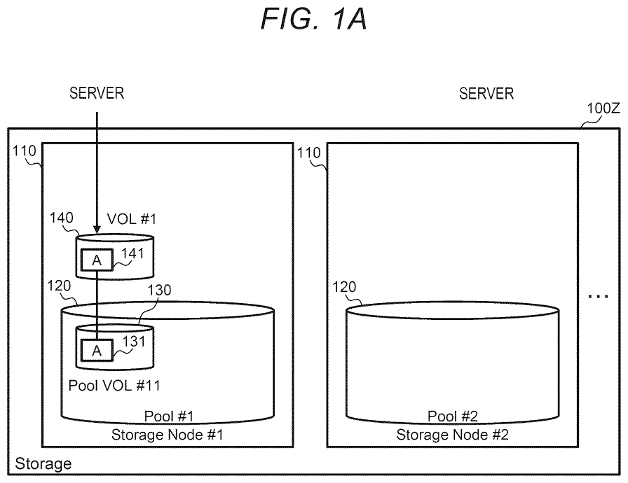

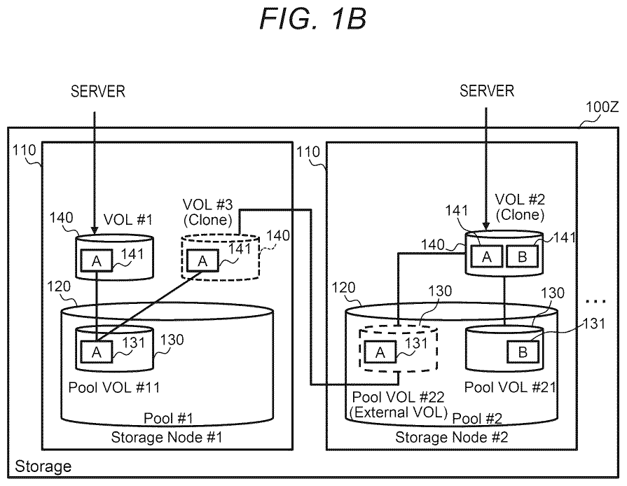

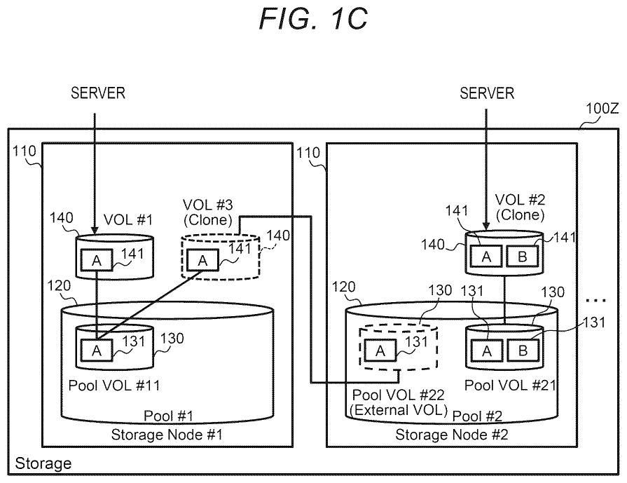

FIG. 1A is a diagram illustrating a configuration of a storage 100Z. As illustrated in FIG. 1A, the storage 100Z includes a plurality of storage nodes 110 (storage node #1, storage node #2, . . .). Each storage node 110 includes a pool (Pool) 120, a pool volume (Pool VOL) 130, and a volume (VOL) 140 as logical configurations.

The pool volume 130 is a logical storage device (logical volume) managed by the storage 100Z, and the pool 120 is created by integrating one or more pool volumes 130. The volume 140 is a virtual volume created from the pool 120. Data of the volume 140 is managed in units of pages 141.

The volume 140 is a volume that is read and written by receiving an IO from a server (or a host), and is associated with a belonging pool (the pool 120 as a creation source). In the page 141, an address of an allocation destination is managed. For example, in the case of FIG. 1A, the volume 140 (virtual volume #1) is associated with the pool 120 (pool #1) including the pool volume 130 (pool volume #11). The page 141 of “A” in the volume #1 is allocated to a page 131 of “A” in the pool volume #11.

### Clone Creation Processing

FIG. 1B is a diagram illustrating a processing image of clone creation processing.

A “clone creation instruction” for creating, in a predetermined storage node 110, a clone of the volume 140 accessible from the server is transmitted to the storage 100Z having the configuration illustrated in FIG. 1A. The clone creation processing is started when the storage node 110 serving as a clone source receives the “clone creation instruction”. In FIG. 1B, it is assumed that, in the “clone creation instruction”, the server instructs the storage node 110 (storage node #1) to create a clone of the volume 140 (volume #1) in the volume 140 (volume #2) of the storage node 110 (storage node #2) that is another node.

Then, in response to the “clone creation instruction”, a replication volume (volume #3 (clone) that is a clone of the volume #1) of the volume (volume #1) serving as the clone source is created in the same storage node #1 as the clone source. As illustrated in FIG. 1B, the page 131 of the pool volume #11 allocated to the page 141 of the volume #1 is also allocated to the page 141 of the volume #3 (clone).

In a clone destination node (storage node #2), the replication volume (volume #3 (clone)) is externally connected to the pool volume 130 (pool volume #22 (Extra VOL)) of the clone destination node (storage node #2). Accordingly, the clone source node (storage node #1) can handle the pool volume 130 (pool volume #22 (Extra VOL)) of the clone destination node (storage node #2) as an external volume externally connected from the clone source node (storage node #1).

Further, in the clone destination node (storage node #2), the page 141 in the clone destination volume (volume #2 (clone)) mapped to data of the replication volume (volume #3 (clone)) and the page 131 in the external volume (pool volume #22) to which the replication volume (volume #3 (clone)) is externally connected are associated with each other one to one.

When the server accesses the page 141 of “A” in the clone destination volume (volume #2 (clone)), since the page 141 is mapped to the volume #3 (clone) via the pool #2, real data of the page 131 of “A” in the pool #1 is accessed via the volume #3 (clone). Further, writing can be performed to the volume #2 (clone) independently of the volume #1, and in this case, a written “B” is stored in the pool volume #21 of the pool #2.

When the page 141 of “A” in the clone source volume is updated, this update is reflected only in volume #1. As a method thereof, a method of backing up “A” in another page, rewriting a mapping destination page of the page 141 of the volume #3 to the page, and then updating the data of the page 131 is considered. As another method, a method of allocating a new page to the pool volume 130, writing new data to the page, and changing the mapping destination of the page 141 to the page is considered.

### Replication Processing

In the state in FIG. 1B, when creating the clone destination volume (volume #2 (clone)) in a plurality of storage nodes 110, there is a problem that a load increases due to concentration of access to the pool volume #11 of the storage node #1 via the volume #3 (clone).

Therefore, as illustrated in FIG. 1C, data of the pool volume #11 to be referred to via the volume #3 (clone) is replicated to the pool volume #21, and the pool volume #21 is accessed from the volume #2 (clone). Accordingly, even when creating the clone destination volume (volume #2 (clone)) in the plurality of storage nodes 110, since the access is distributed to each storage node 110, the load concentrated on the storage node #1 can be distributed. Another clone volume may be created using the volume #2 (clone) and the pool volume #21. Note that this processing is an example of replication creation processing performed via clone processing, and a replica may be created by another method.

### Outline of First Embodiment

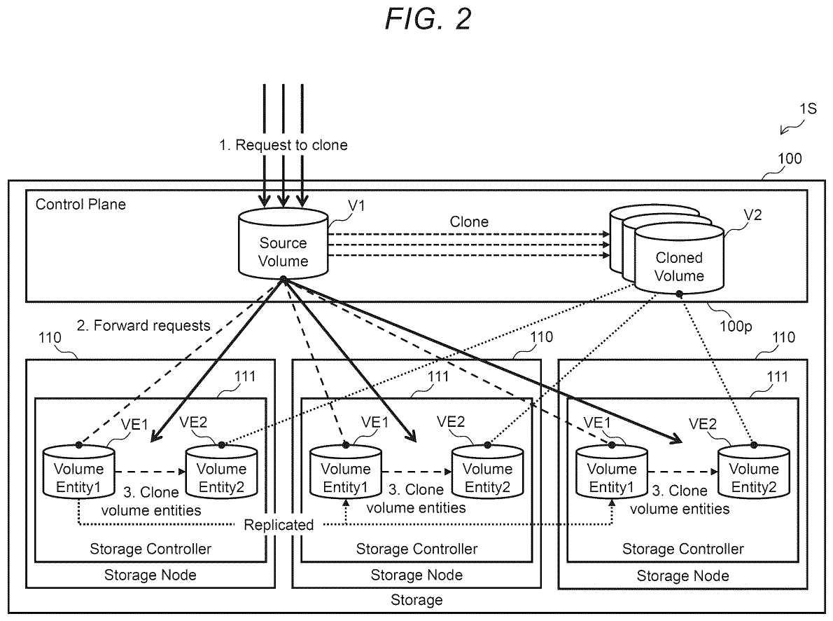

FIG. 2 is a diagram illustrating an outline of the first embodiment. In the first embodiment, a control plane 100p of an information processing system S including a storage 100 controls replication of a user-specified volume between nodes. The storage 100 is an example of a storage system.

In the storage 100, a volume V1 is provided for a server. In the storage 100, the volume V1 designated as a clone source volume to be cloned is associated with a plurality of volume entities VE1 as entities of volumes. In the storage 100, the volume entity VE1, which is the clone source volume, is replicated and distributed to the plurality of storage nodes 110, but is shown as one volume as a management operation object of a user. The volume entity VE1 is created by copying another volume entity according to a copy instruction, and each volume entity VE1 has data stored in the volume V1, and stores data in association with a storage area of a storage medium. Data written to the volume V1 is written to each of the plurality of volume entities VE1, and when reading the data, the data is read from any one of the volume entities VE1.

When a clone operation for the volume V1 is requested (1. Request to clone), the control plane 100p specifies the volume entity VE1 associated with the volume V1. Thereafter, the control plane 100p selects, as a clone destination node, one storage node 110 from storage nodes 110 that manage the specified volume entity VE1 in accordance with an available capacity of the storage node 110.

The control plane 100p requests a storage controller 111 operating in the selected storage node 110 to create a clone of the volume entity VE1 (2. Forward requests). The storage controller 111 that receives the clone creation request executes clone creation of the volume entity VE1 (3. Clone volume entity).

Here, in the related art, there is one volume entity VE1 associated with the volume V1 serving as the clone source. In this case, when creating a plurality of clones of the volume V1, data accesses from a plurality of volume entities VE2 associated with a clone destination volume V2 is concentrated on the storage node 110 having one volume entity VE1 associated with the volume V1 as described above with reference to FIG. 1B.

On the other hand, in the first embodiment, a plurality of clone source volume entities VE1 associated with the clone source volume V1 are managed in a distributed manner by a plurality of storage controllers 111. Therefore, when creating a plurality of clones of the volume V1 and a plurality of volumes V2, volume entities VE2 associated with the respective volumes V2 exist individually. The volume entities VE2 are distributed to the storage nodes 110 having the respective volume entities VE1. Therefore, it is possible to prevent a load involving the data access of the plurality of volume entities VE2 from concentrating on the specific storage node 110.

### Configuration of Information Processing System S According to First Embodiment

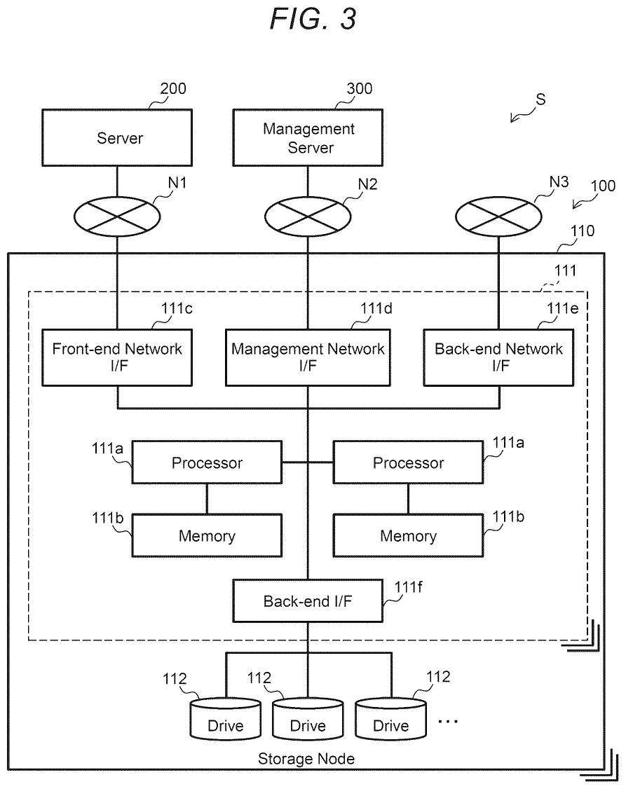

FIG. 3 is a diagram illustrating a configuration of the information processing system S according to the first embodiment.

The information processing system S includes the storage 100 including a plurality of storage nodes 110, a server 200, and a management server 300. The storage node 110, the server 200, and the management server 300 have a general computer configuration.

The server 200 runs an application, a virtual machine, and a container that use a volume created in the storage 100, a virtualization platform that controls running of the application, the virtual machine and the container, and the like. The server 200 transmits an input and output (IO) request to a volume entity of the storage node 110 and receives an IO response to the IO request from the storage node 110.

The management server 300 transmits a request related to configuration management of the storage 100 to the storage 100 in response to a user input.

The storage node 110 includes one or more storage controllers 111 and one or more drives 112.

The storage controller 111 includes a processor 111a, a memory 111b, a front-end network I/F 111c, a management network I/F 111d, a back-end network I/F 111e, and a back-end I/F 111f.

The processor 111a executes various types of processing of the storage controller 111 in cooperation with the memory 111b.

The processor 111a receives an IO request from the server 200 via a front-end network N1 and the front-end network I/F 111c, and accesses a volume entity on the drive 112. The processor 111a transmits an IO response to the IO request to the server 200 via the front-end network N1 and the front-end network I/F 111c.

The processor 111a receives a request related to configuration management of the storage 100 from the management server 300 via a management network N2 and the management network I/F 111d, and executes various types of processing related to the configuration management.

In addition, the processor 111a executes data redundancy such as erasure coding (EC) in order to protect data of a volume entity managed by the processor 111a.

The copy of the volume entity is performed via the front-end network N1 and the front-end network I/F 111c or a back-end network N3 and the back-end network I/F 111e. When the storage nodes 110 are connected to each other via the front-end network N1 and the front-end network I/F 111c, the volume entity can be copied via the front-end network N1.

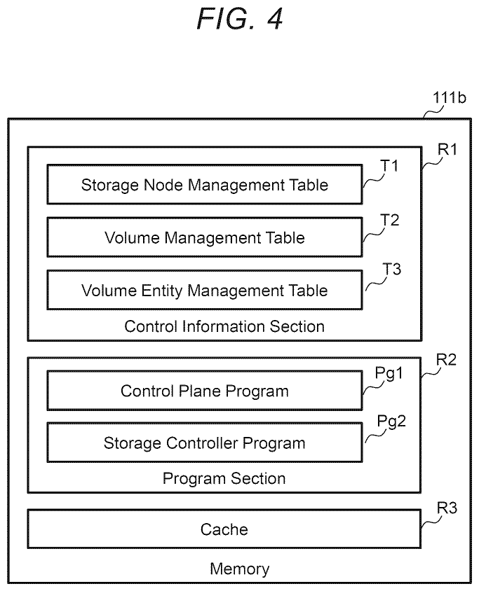

Configuration of Memory 111b According to First Embodiment FIG. 4 is a diagram illustrating a configuration of the memory 111b provided in the storage node 110 according to the first embodiment. The memory 111b provided in the same storage node 110 has the same configuration.

The memory 111b includes a control information storage area R1, a program storage area R2, and a cache area R3.

The control information storage area R1 stores a storage node management table T1, a volume management table T2, and a volume entity management table T3. Details of these tables will be described later. These pieces of information may be stored in the drive 112 for non-volatilization, and the memory 111b may have caches thereof.

The program storage area R2 stores a control plane program Pg1 and a storage controller program Pg2 to be executed by the processor 111a.

The control plane program Pg1 is a program that implements the control plane 100p (FIG. 2), and executes various types of processing related to configuration management of the storage 100 including creation of a volume clone. The storage controller program Pg2 executes control of the storage 100 including processing of an IO request.

The cache area R3 is a temporary storage area for data related to an IO request when the IO request from the server 200 is processed.

### Storage Node Management Table T1 According to First Embodiment

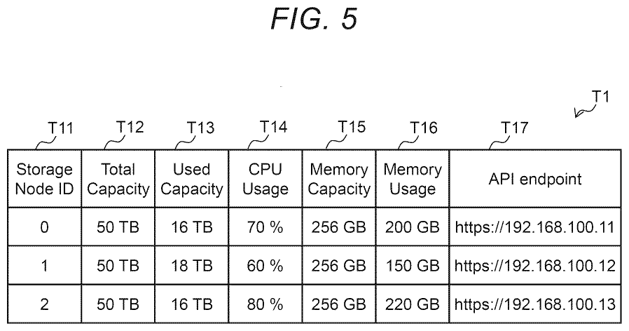

FIG. 5 illustrates a configuration of the storage node management table T1 according to the first embodiment. The storage node management table T1 is information for managing the storage node 110, and is held in the memory 111b of the storage node 110 as information managed by the control plane 100p.

The storage node management table T1 includes items of a storage node ID T11, a total capacity T12, a used capacity T13, a CPU usage T14, a memory total capacity T15, a memory usage T16, and an API endpoint T17.

The storage node management table T1 manages the total capacity and the used capacity, the usage of the CPU (processor 111a), the total capacity and the used capacity of the memory 111b, and the API endpoint, for each storage node 110 identified by the storage node ID T11.

The control plane 100p determines an available capacity of each storage node 110 based on resource usage managed by the storage node management table T1, and determines which storage node 110 has a volume entity for which a clone should be created.

### Volume Management Table T2 According to First Embodiment

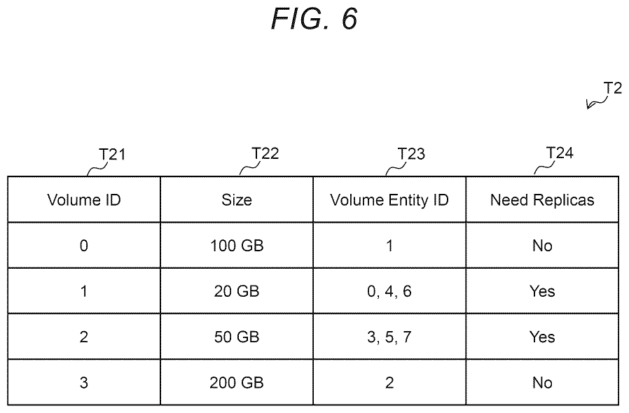

FIG. 6 illustrates a configuration of the volume management table T2 according to the first embodiment. The volume management table T2 is information for managing a volume, and is held in the memory 111b of the storage node 110 as information managed by the control plane 100p.

The volume management table T2 includes items of a volume ID T21, a volume size T22, a volume entity ID T23, and a replication necessity flag T24. The volume management table T2 manages a correspondence relation between one volume and one or more volume entities.

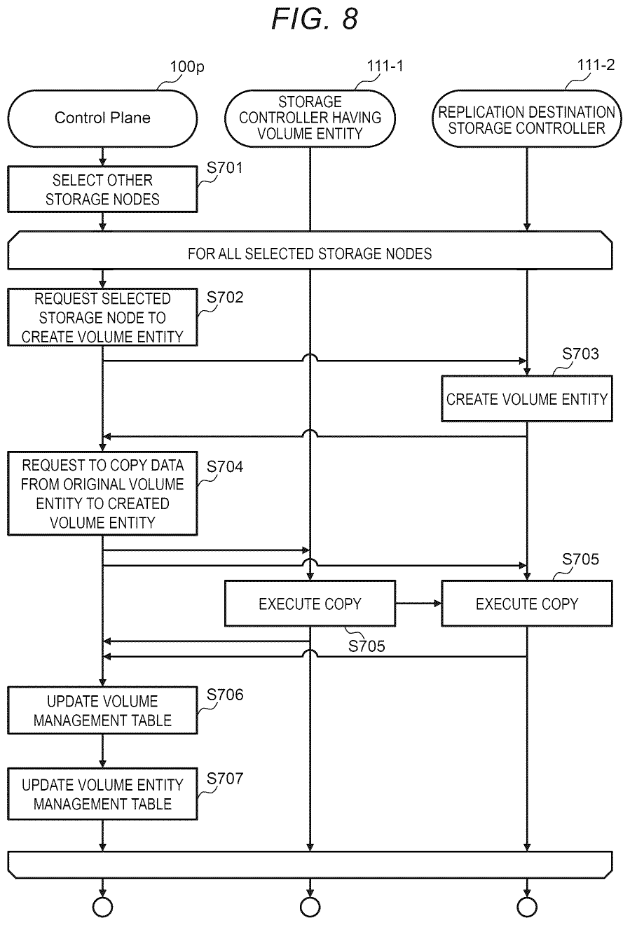

The replication necessity flag T24 is flag information indicating whether a volume identified by the volume ID T21 needs to be replicated between the storage nodes 110, and is designated by the user as a volume attribute. When the replication necessity flag T24 is changed to “YES”, volume entity replication processing (FIG. 8) described later is executed, and the volume entity is replicated between the storage nodes 110.

### Volume Entity Management Table T3 According to First Embodiment

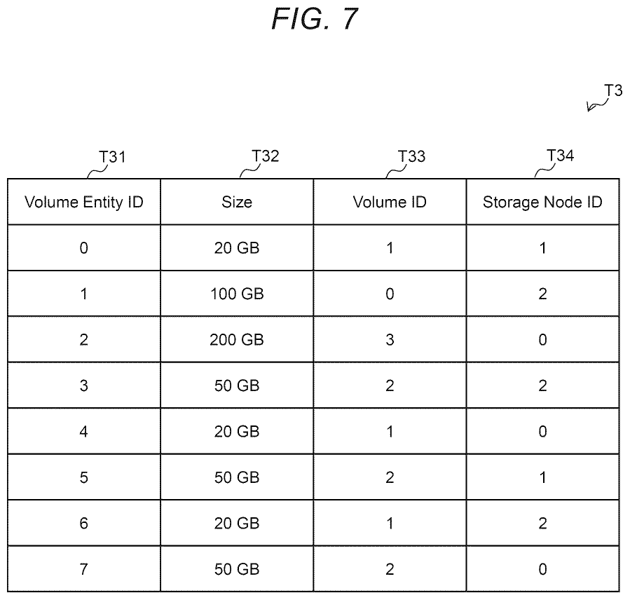

FIG. 7 illustrates a configuration of the volume entity management table T3 according to the first embodiment. The volume entity management table T3 is information for managing a volume entity, and is held in the memory 111b of the storage node 110 as information managed by the control plane 100p.

The volume entity management table T3 includes items of a volume entity ID T31, a volume entity size T32, a volume ID T33, and a storage node ID T34. The volume entity management table T3 manages identification information on a volume associated with a volume entity and the storage node 110 that manages the volume entity.

### Volume Entity Replication Processing According to First Embodiment

FIG. 8 is a sequence diagram illustrating the volume entity replication processing according to the first embodiment. The volume entity replication processing is executed synchronously or asynchronously with the change of the replication necessity flag T24 (FIG. 6) of each volume to “YES”.

The volume entity replication processing illustrated in FIG. 8 is executed between a storage controller 111-1 having a volume entity associated with a clone source volume and a storage controller 111-2 serving as a replication destination of the volume entity.

First, in step S701, the control plane 100p selects, as a replication destination storage node, another storage node 110 constituting the storage 100. In step S701, for example, all the storage nodes 110 constituting the storage 100 are selected as replication destination storage nodes. The replication destination storage node may be selected based on at least one of the following (1-1) to (1-3).

### (1-1) Usage of Resources of Storage Node 110

The resource usage is, for example, a capacity usage, a CPU usage, or a memory usage obtained with reference to the storage node management table T1 (FIG. 5). The storage node 110, in which one or more of these parameters exceed a threshold and there is no available capacity, may be excluded from the selection of the replication destination storage node.

### (1-2) Whether Path From Server 200 Using Volume Is Established

The storage node 110 may be selected based on whether a path from the server 200 that uses the volume is established. This is because, even if a replication volume of a volume entity and a clone of the replication volume are created, an IO cannot be transmitted from the server 200 unless a path that permits access from the server 200 to the storage node 110 is created. By excluding the storage node 110 having no path from the selection of the replication destination storage node, it is guaranteed that the volume entity created by the clone can be accessed from the server 200.

### (1-3) Estimated Number of Clones to be Created for Volume

The replication destination storage node may be selected as follows. That is, information on the estimated number of clones to be created for a volume that is likely to be cloned in the future is given as a volume attribute, and when “YES” is set to the replication necessity flag T24 (FIG. 6), the information is set for each volume at the same time. Then, a required number of storage nodes 110 is estimated according to equation (1) based on the estimated number of clones to be created, and the estimated required number of replication destination storage nodes are selected. The equation (1) may be multiplied by a weighting factor larger than 1, and the volume entity may be replicated in storage nodes 110 in the number larger than the required number.

The required number of storage nodes 110=(the number of clones in the future)/(the maximum number of volumes that can be held in the storage node 110) ··· (1)

When the estimated required number of storage nodes 110 is less than the number of storage nodes 110 in the storage 100, the storage node 110 having a larger available capacity may be preferentially selected in consideration of a load status.

Next, steps S702 to S707 are executed for all the storage nodes 110 selected in step S701.

In step S702, the control plane 100p transmits a volume entity creation request to the storage node 110 (storage controller 111-2) selected in step S701.

Next, in step S703, the storage controller 111-2 creates the volume entity and transmits volume entity creation completion to the control plane 100p.

Next, in step S704, the control plane 100p requests the storage controller 111-1 having a replication source volume entity to copy data from the replication source volume entity to a replication destination volume entity.

Next, in step S705, the storage controller 111-1 and the storage controller 111-2 execute data copy from the replication source volume entity to the replication destination volume entity. In steps S703 and S705, a clone source volume entity is created. Then, the storage controller 111-1 and the storage controller 111-2 transmit data copy execution completion to the control plane 100p.

The data copy of the volume entity in step S705 can use a volume replication technique that is a known technique. In the volume replication technique, data is redundantly held in a plurality of storage nodes 110, which increases the data holding cost.

Therefore, it is also possible to apply a method of using a function of handling a volume of an external storage as a volume of an own storage to handle a corresponding volume entity from another storage node 110. When this method is applied, since only one storage node 110 has an entity of data, the cost for holding data can be reduced. On the other hand, since the entity of the data does not exist in the storage node 110 serving as a replication destination, there is a disadvantage that remote access is performed at the time of data access and data access performance decreases.

The volume replication technique has a disadvantage of increasing the cost of holding data, but since the entity of data also exists in the storage node 110 serving as the replication destination, it is possible to avoid a decrease in data access performance.

Therefore, the method of copying data of the volume entity is used depending on the use of the storage 100 or the volume.

Next, in step S706, an entry related to a correspondence relation between the volume to be processed and the replicated volume entity (clone source volume entity) is added to the volume management table T2 (FIG. 6). Next, in step S707, the control plane 100p adds an entry related to a correspondence relation between the clone source volume entity and the replication destination storage node to the volume entity management table T3 (FIG. 7). The replication destination storage node is the storage node 110 having the clone source volume entity.

For the volume for which the volume entity replication processing illustrated in FIG. 8 is completed, the replication necessity flag T24 in the volume management table T2 (FIG. 6) is updated to “NO”.

There is a technique of continuously synchronizing the data update for the clone source volume, for which the replication necessity flag T24 (FIG. 6) is changed to “YES”, with a copy destination volume entity in step S705 (see, for example, PTLs 2 and 3). There is also a technique of copying on demand at the time of data access (see, for example, PTL 4). Accordingly, the data update for the replication source volume entity is continuously synchronized with the copy destination volume entity, and clone can be performed based on the latest data. As another method for guaranteeing the identity between the replication source volume entity and the replication destination volume entity, it is also possible to prohibit updating to the replication source volume entity before copying.

### Clone Processing According to First Embodiment

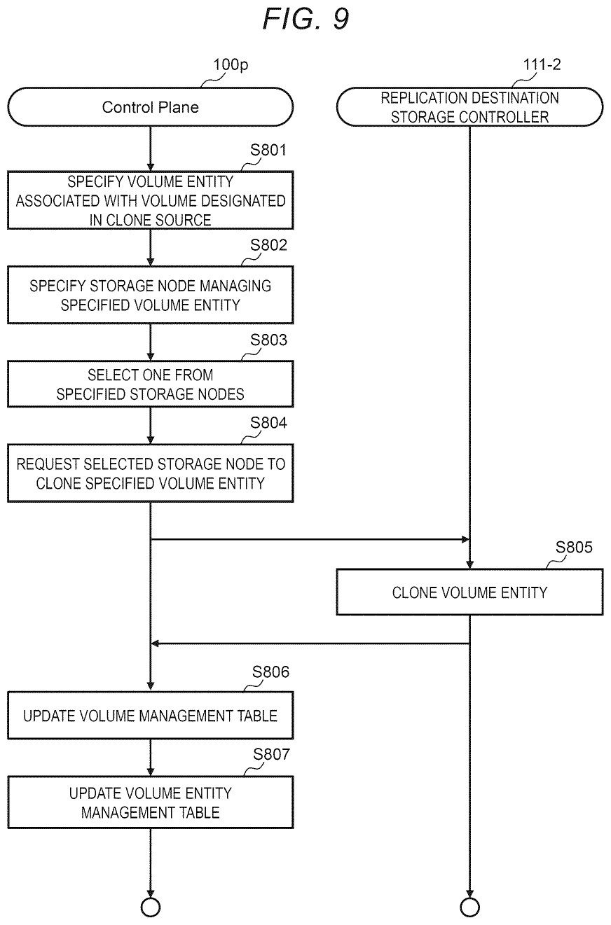

FIG. 9 is a sequence diagram illustrating clone processing according to the first embodiment. The clone processing according to the first embodiment is processing executed when a volume clone request is received.

First, in step S801, the control plane 100p specifies a volume entity associated with a volume designated as a clone source. Next, in step S802, the control plane 100p specifies the storage node 110 that manages the volume entity specified in step S801.

Next, in step S803, the control plane 100p selects, as a clone destination storage node, one of the storage nodes 110 specified in step S802. The control plane 100p may select the clone destination storage node based on at least one of the following (2-1) to (2-3).

(2-1) Resource Usage of Storage Node 110 that Manages Volume Entity

In order to distribute the load, the clone destination storage node may be selected based on resource usage of the storage node 110 that manages the volume entity. For example, the storage node 110 having the maximum available capacity is selected. The storage node 110 having a large available capacity is the storage node 110 having the lowest usage based on usage of the CPU, the memory, and the storage capacity in the storage node management table T1 (FIG. 5).

(2-2) Whether There is Path Accessible from Server 200 Using Volume.

One of volume entities of the storage node 110 may be selected depending on whether there is a path accessible from the server 200 that uses the volume. When a plurality of storage nodes 110 has the path, it is possible to make a selection from the storage nodes 110 based on the above-described available capacity.

### (2-3) Designation of Location of Storage Node 110 Included in Clone Creation Request

When the storage node 110 has information on a location such as an availability zone and the clone creation request includes designation of a storage node 110 at a location in which a clone is to be created, the storage node 110 satisfying the designation may be selected.

Next, in step S804, the control plane 100p transmits a clone creation request for the volume entity specified in step S801 to the storage node 110 selected in step S803.

Next, in step S805, the storage controller 111-2 of the storage node 110 selected in step S803 creates a clone of the volume entity requested to be cloned in step S804, and transmits creation completion to the control plane 100p.

Next, in step S806, the control plane 100p adds information on a correspondence relation between the clone created in step S805 and the replication destination storage node to the volume management table T2 (FIG. 6). Next, in step S807, the control plane 100p adds information on a correspondence relation between the clone created in step S805 and the clone source volume to the volume entity management table T3 (FIG. 7).

### Effects of First Embodiment

In the first embodiment, when creation of a clone of a volume entity is requested, a clone source volume entity serving as a clone source of the clone is created in a replication destination storage node. Therefore, even when cloning a large number of volumes from one volume, the IO load and the capacity can be distributed to a plurality of storage nodes. Since there is no occurrence of too much volume movement, it is possible to reduce a network load between storage nodes, reduce network investment, and quickly complete clone creation in response to a clone request.

Further, in the first embodiment, the replication destination storage node is selected based on at least one of the resource usage of the storage node, a setting condition of a path related to the access to each storage node from the server, and the estimated number of clones to be created in the future in each storage node. Therefore, since an appropriate storage node is selected as the replication destination storage node according to the situation and the replication of the clone source volume entity is arranged in advance, it is possible to quickly create a clone without delay in response to a clone creation request.

In the first embodiment, the clone source volume entity associated with the volume to be cloned is specified, the replication destination storage node associated with the specified clone source volume entity is specified, and the clone destination storage node is selected from specified replication destination storage nodes. Then, a clone of the clone source volume entity is created in the selected clone destination storage node. Therefore, it is possible to select an appropriate storage node according to the situation and quickly create a clone.

Further, in the first embodiment, the clone destination storage node is selected based on at least one of the resource usage of the replication destination storage node, the setting condition of the path related to the access to each replication destination storage node from the server, and an instruction of a location of the clone destination storage node. Therefore, it is possible to quickly create a clone without delay in response to a clone creation request, and it is possible to quickly create a clone by selecting a more appropriate storage node from among replication destination storage nodes in which the replication of the clone source volume entity is arranged in advance.

### Second Embodiment

In the first embodiment, the user determines whether it is necessary to replicate a volume entity, and the user sets the replication necessity flag T24 (FIG. 6). In contrast, in the second embodiment, the control plane 100p determines whether it is necessary to replicate a volume entity.

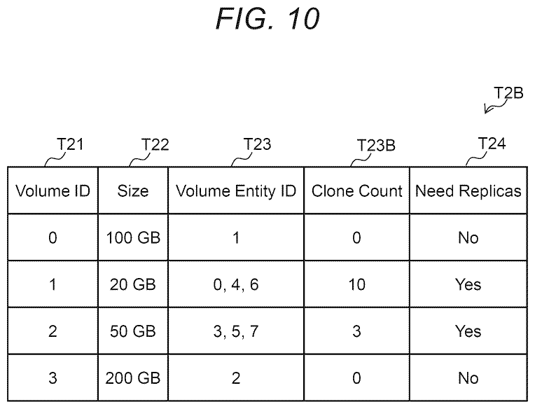

In the second embodiment, instead of the volume management table T2 (FIG. 6), a volume management table T2B (FIG. 10), which manages information on the number of times of performed clone creation with each volume as a clone source, is used.

### Volume Management Table T2B According to Second Embodiment

FIG. 10 illustrates the volume management table T2B according to the second embodiment. The volume management table T2B further includes an item of a clone creation count T23B as compared with the volume management table T2 (FIG. 6) according to the first embodiment.

The clone creation count T23B is information on the number of times of performed clone creation with each volume as a clone source. The clone creation count T23B is an example of creation record information for each volume accumulated every time a clone is created in a clone destination storage node.

### Volume Entity Replication Necessity Determination Processing According to Second Embodiment

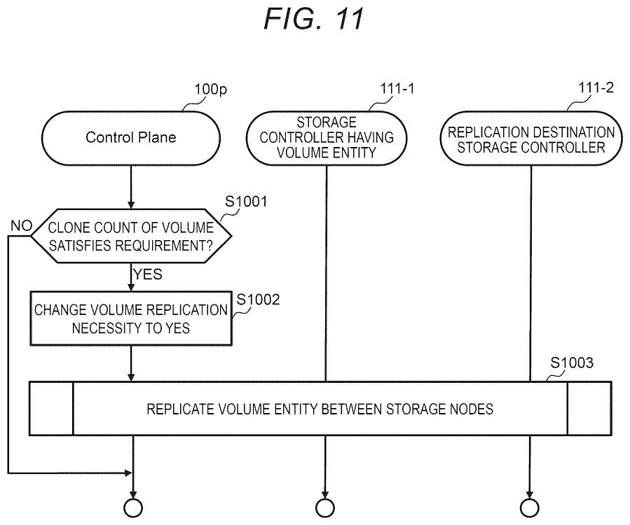

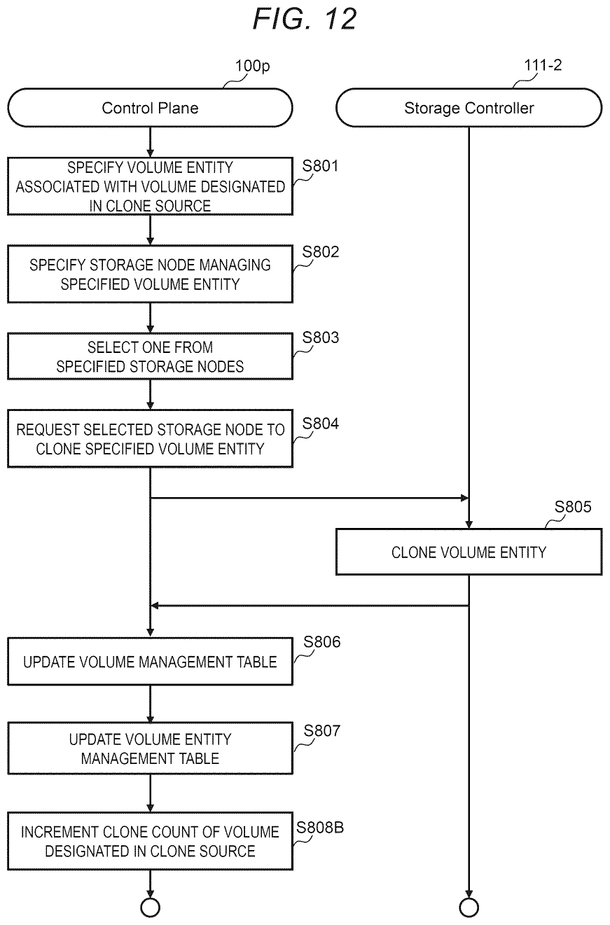

FIG. 11 is a flowchart illustrating volume entity replication processing according to the second embodiment. First, in step S1001, the control plane 100p determines whether the clone creation count T23B of each volume identified by the volume ID T21 in the volume management table T2B (FIG. 10) satisfies a predetermined condition. The predetermined condition is, for example, that a clone having a capacity of a certain ratio of a volume that can be provided by one node is created, or that a clone is created a predetermined number of times (for example, two or more times). The “capacity of the created clone” is also an example of the creation record information for each volume accumulated every time a clone is created in the clone destination storage node.

The control plane 100p advances the processing to step S1002 when the predetermined condition is satisfied (YES in step S1001), and ends the volume entity replication processing when the predetermined condition is not satisfied (NO in step S1001).

In step S1002, the control plane 100p changes the replication necessity flag T24 of the volume satisfying the predetermined condition to “YES” in the volume management table T2B (FIG. 10). Next, in step S1003, the control plane 100p, the storage controller 111-1, and the storage controller 111-2 execute the same processing as the volume entity replication processing (FIG. 8) according to the first embodiment. The storage controller 111-1 is a storage controller having a replication source volume entity. The storage controller 111-2 is a storage controller having a replication destination volume entity. Step S1003 is executed synchronously or asynchronously with steps S1001 and S1002.

### Clone Processing According to Second Embodiment

FIG. 12 is a sequence diagram illustrating clone processing according to the second embodiment. The clone processing according to the second embodiment is different from the clone processing according to the first embodiment (FIG. 9) in that the clone creation count T23B of the clone source volume is incremented (+1) in step S808B when the clone is performed. Other parts of the processing are the same as those of the first embodiment.

If the clone creation count T23B is only incremented, the influence of clone creation executed in the remote past remains. Therefore, the clone creation count T23B may be periodically subtracted to eliminate the influence. Examples of the subtraction method include a method of periodically initializing the clone creation count T23B to zero and a method of periodically multiplying the clone creation count by a weight coefficient less than 1 and performing subtraction in a stepwise manner.

### Effects of Second Embodiment

In the second embodiment, creation record information for each volume accumulated every time a clone is created in a clone destination storage node is managed, and a clone source volume entity is created for a volume of which the creation record information satisfies a predetermined condition. Therefore, since replication of the clone source volume entity is arranged in advance for a volume having a record showing its clone is easily created, the clone source volume entity can be efficiently arranged.

In the second embodiment, the creation record information is periodically initialized or subtracted. Therefore, it is possible to appropriately determine the volume, for which clone source volume entities are distributed and arranged in storage nodes, based on the appropriate creation record information by excluding the old influence of the past clone creation.

### Third Embodiment

### Outline of Third Embodiment

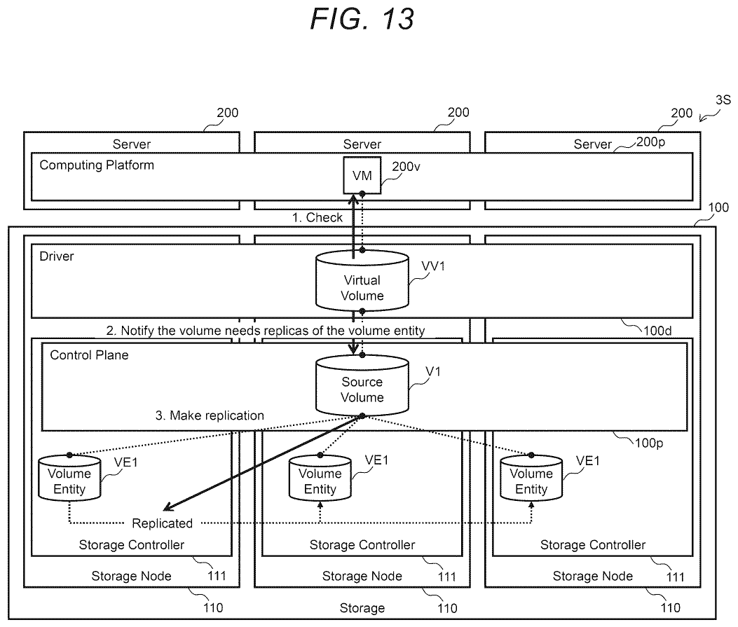

FIG. 13 is a diagram illustrating an outline of a third embodiment. In the third embodiment, an information processing system 3S includes a virtual machine platform 200p that uses the volume V1, and a driver 100d for the virtual machine platform 200p and the storage 100 to operate cooperatively. The driver 100d substitutes the control plane 100p to execute a part of the control content of the control plane 100p in the second embodiment. FIG. 13 illustrates a mode in which the driver 100d is implemented in the storage 100, and the embodiment of the invention is not limited thereto. For example, the driver 100d may be implemented in a server existing outside the storage 100.

A virtual machine 200v operating on the virtual machine platform 200p is provided with a virtual volume VV1 via the driver 100d. The virtual volume VV1 is managed by the driver 100d. The virtual volume VV1 is management information for connecting the volume V1 and the virtual machine 200v.

The virtual machine platform 200p and the virtual machine 200v are examples of a computing platform and virtual computing resources. The computing platform and the virtual computing resources are not limited to the virtual machine platform 200p and the virtual machine 200v, and may be another platform and computing resources in another platform such as a container platform and a container.

In the third embodiment, the volume entity replication necessity determination (step S1001) of the volume entity replication processing (FIG. 11) in the second embodiment is executed based on configuration information of the virtual machine platform 200p that uses a volume, instead of the clone creation count T23B (FIG. 10).

For example, in the virtual machine platform 200p, since a new virtual machine is created by cloning the virtual machine 200v that is a golden image, there is a high possibility that a clone is created for a volume used by the virtual machine 200v for which a golden image is designated. The golden image is a general-purpose template capable of implementing various virtual machine environments.

In the third embodiment, first, it is checked whether a golden image is designated for the virtual machine 200v (1. Check). When a golden image is designated for the virtual machine 200v, it is determined that there is a possibility that a large number of clones are to be created, and the storage 100 is instructed to replicate the volume entity VE1 associated with the volume V1 used by the virtual machine 200v (the replication necessity flag T24 is set to “YES” (2. Notify the volume needs replicas of the volume entity)). A replica of the volume entity VE1 is created (3. Make replication).

### VM Management Table T4 According to Third Embodiment

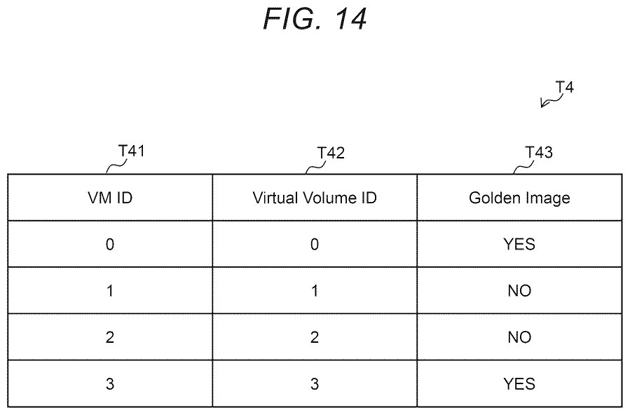

FIG. 14 illustrates a configuration of a VM management table T4 according to the third embodiment. The VM management table T4 is managed by the virtual machine platform 200p.

The VM management table T4 includes items of a virtual machine ID T41, a virtual volume ID T42, and a golden image attribute T43. The VM management table T4 manages the virtual volume ID T42, which is identification information of a virtual volume used by the virtual machine 200v identified by the virtual machine ID T41, and the golden image attribute T43 indicating whether the virtual machine 200v is a golden image.

When the computing platform is not the virtual machine platform 200p but a container platform, the same control as that of the virtual machine can be applied by using identification information of a management unit in the computing platform such as a container or a set of containers, instead of the virtual machine ID T41. The container and the set of containers are, for example, Deployment and StatefulSet in Kubernetes (registered trademark, the same applies hereinafter).

### Virtual Volume Management Table T5 According to Third Embodiment

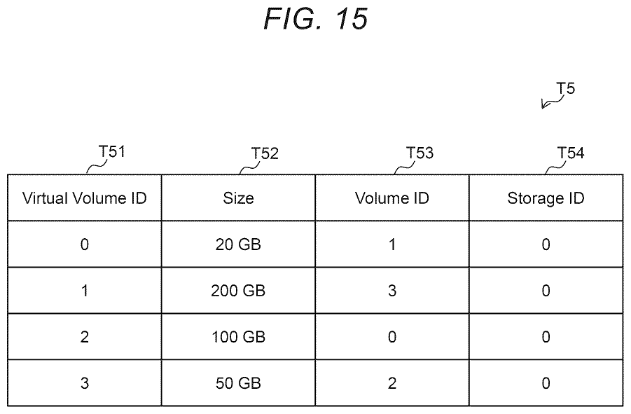

FIG. 15 illustrates a configuration of a virtual volume management table T5 according to the third embodiment. The virtual volume management table T5 is a management table of virtual volume, and is managed by one or both of the driver 100d and the virtual machine platform 200p.

The virtual volume management table T5 includes items of a virtual volume ID T51, a virtual volume capacity ID T52, a volume ID T53, and a storage ID T54. The virtual volume management table T5 manages the virtual volume capacity ID T52 of the virtual volume identified by the virtual volume ID T51, and identification information of a volume and the storage 100 that are associated with each other.

When the computing platform is Kubernetes, which is a representative example of a container platform, the same control as that of the virtual machine platform 200p can be performed by setting the virtual volume to Persistent Volume or Persistent Volume Claim.

### Volume Entity Replication Processing According to Third Embodiment

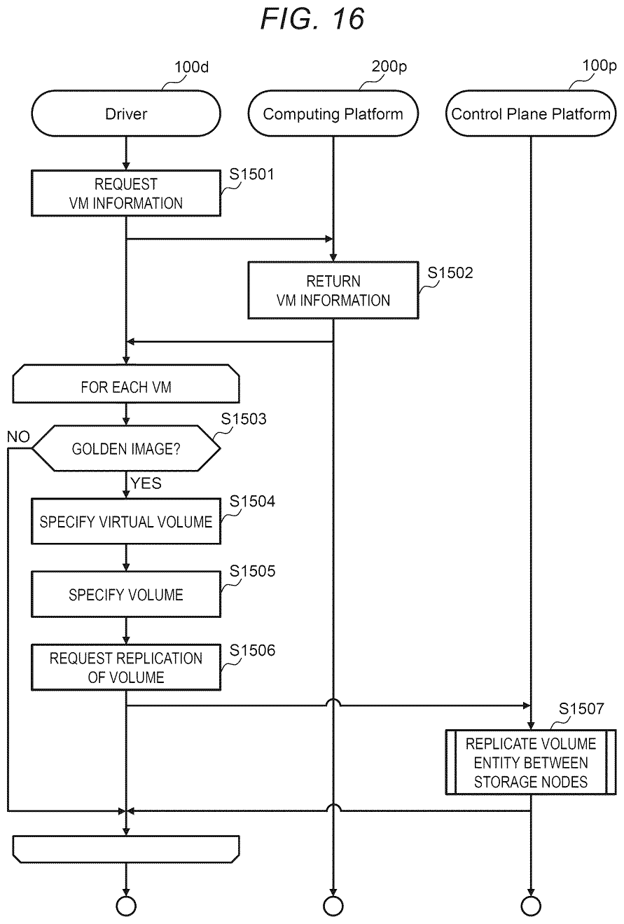

FIG. 16 is a sequence diagram illustrating volume entity replication processing according to the third embodiment. In the volume entity replication processing according to the third embodiment, it is determined whether replication of the volume entity VE1 is necessary based on information on the virtual machine 200v that uses a volume, and the replication is executed as necessary.

First, in step S1501, the driver 100d requests the virtual machine platform 200p for virtual machine information related to the virtual machine 200v. Next, in step S1502, the virtual machine platform 200p transmits the virtual machine information related to the virtual machine 200v to the driver 100d.

Next, steps S1503 to S1507 are executed for all the virtual machines 200v to which the virtual machine information is transmitted in step S1501.

In step S1503, the driver 100d determines whether the golden image attribute T43 of the virtual machine information of the corresponding virtual machine 200v is “YES”. When the golden image attribute T43 of the corresponding virtual machine 200v is “YES” (YES in step S1503), the driver 100d advances the processing to step S1504. On the other hand, when the golden image attribute T43 is “NO” (NO in step S1503), the driver 100d executes step S1503 for the virtual machine information of the next virtual machine 200v.

In step S1504, the driver 100d refers to the VM management table T4 (FIG. 14) and specifies the virtual volume T42 associated with the virtual machine 200v for which the golden image attribute T43 is determined to be “YES”. Next, in step S1505, the driver 100d refers to the virtual volume management table T5 (FIG. 15) and specifies a volume associated with the virtual volume T42 specified in step S1504.

Next, in step S1506, the driver 100d requests the control plane 100p to replicate the volume specified in step S1505. This request is made by changing the replication necessity flag T24 (FIG. 6) of the volume to “YES”.

Next, in step S1507, the control plane 100p, the storage controller 111-1, and the storage controller 111-2 execute the same processing as the volume entity replication processing (FIG. 8) according to the first embodiment. The storage controller 111-1 is a storage controller having a replication source volume entity. The storage controller 111-2 is a storage controller having a replication destination volume entity. Step S1507 is executed synchronously or asynchronously with steps S1503 to S1506.

When step S1506 (executed synchronously with step S1507) or step S1507 (executed asynchronously with step S1506) ends, the driver 100d executes step S1503 for the virtual machine information of the next virtual machine 200v. When the execution of steps S1503 to S1507 ends for the virtual machine information of all the virtual machines 200v, the volume entity replication processing ends.

### Effects of Third Embodiment

In the third embodiment, a computing platform and virtual computing resources on the computing platform are implemented in a server, a virtual volume is provided for the virtual computing resources, and a driver that connects the virtual volume and the volume is implemented. When attribute information of the virtual computing resource is a golden image, a clone source volume entity is created. Therefore, in an information processing system including the virtual computing resources, since an appropriate storage node is selected as a replication destination storage node and the replication of a clone source volume entity is arranged in advance, it is possible to quickly create a clone without delay in response to a clone creation request. That is, it is possible to construct a storage environment for virtual machines in which a large number of virtual machines can be deployed.

### Fourth Embodiment

### Outline of Fourth Embodiment

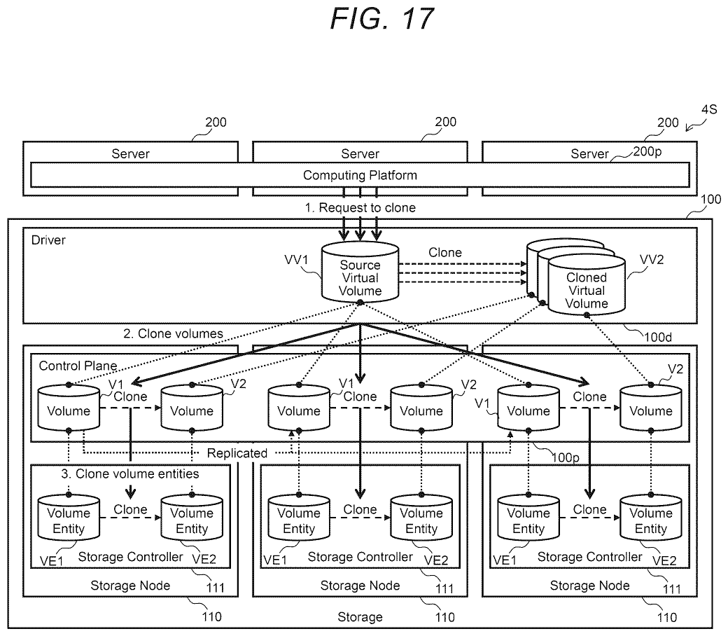

FIG. 17 is a diagram illustrating an outline of a fourth embodiment. An information processing system 4S of the fourth embodiment is different from that of the third embodiment in that the driver 100d executes all of the replication necessity determination and the replication of the volume entity VE1.

The driver 100d does not manage a relation between the volume V1 and the volume entity VE1. Therefore, when it is determined that it is necessary to replicate a volume entity serving as a clone source, the driver 100d creates replicas of the clone source volume V1 in storage nodes in a distributed manner in order to replicate the volume entity VE1 in other storage nodes 110, and associates the replicas with the clone source virtual volume VV1. A method for replication necessity determination of the clone source volume is the same as in the first embodiment to the third embodiment.

Upon receiving a clone creation request of the virtual volume VV1 from the virtual machine platform 200p (1. Request to clone), the driver 100d selects one of a plurality of volumes V1 associated with the virtual volume VV1, and requests the control plane 100p to create a clone of the volume V1 (2. Clone volumes). In response to the request, the control plane 100p creates the volume entity VE2 that is a clone of the volume entity VE1 associated with the volume V1 designated as the clone source volume (3. Clone volume entities).

A method of selecting the storage node 110 serving as the replication destination of the volume entity VE1 is the same as that of the first embodiment.

### Virtual Volume Management Table T5D According to Fourth Embodiment

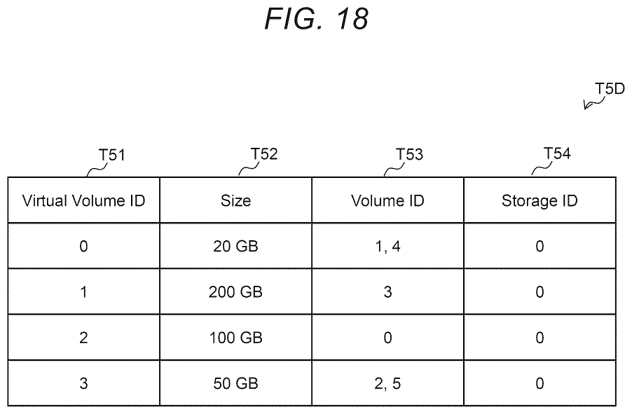

FIG. 18 illustrates a configuration of a virtual volume management table T5D according to the fourth embodiment. The virtual volume management table T5D is different from the virtual volume management table T5 (FIG. 15) according to the third embodiment in that a plurality of volumes ID T53 store one or more volume ID. That is, in the virtual volume management table T5D according to the fourth embodiment, one or more volumes are associated with one virtual volume.

### Volume Entity Replication Processing According to Fourth Embodiment

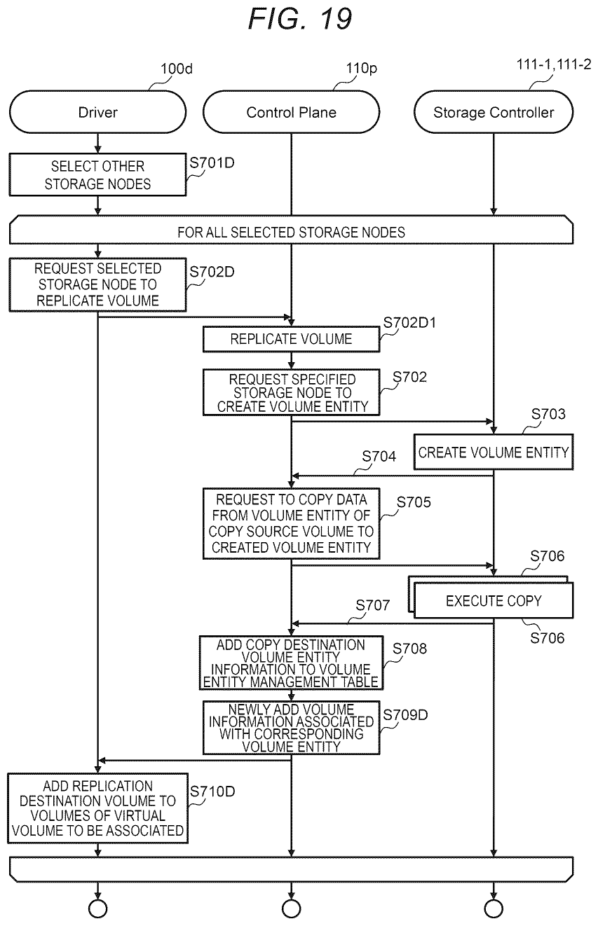

FIG. 19 is a sequence diagram illustrating volume entity replication processing according to the fourth embodiment. The volume entity replication processing according to the fourth embodiment is different from the volume entity replication processing (FIG. 8) according to the first embodiment in that not only the volume entity VE1 but also the volume V1 is replicated. In the description of the volume entity replication processing according to the fourth embodiment, the same steps as those of the volume entity replication processing according to the first embodiment are denoted by the same reference signs, and steps different therefrom are denoted by different reference signs.

First, in step S701D, the driver 100d selects another storage node 110 constituting the storage 100 as in step S701 (FIG. 8).

Next, steps S702D to S710D are executed for all the storage nodes 110 selected in step S701D.

In step S702D, the driver 100d transmits a request to replicate a volume to the storage node 110 (storage controller 111-2) selected in step S701D to the control plane 100p.

Next, in step S702D1, the control plane 100p creates a replication volume of the volume instructed in step S702D in the designated storage node 110.

Next, similarly to the volume entity replication processing (FIG. 8) according to the first embodiment, steps S702 to S708 are executed.

Next, in step S709D, the control plane 100p adds, to the volume management table T2B (FIG. 10), a new entry in which the replication volume replicated in step S702D1 is associated with the volume entity whose data is copied in step S706. When the addition of the new entry in step S709D is completed, the control plane 100p notifies the driver 100d.

Next, in step S710D, the driver 100d updates the virtual volume management table T5D (FIG. 18) by associating the replication volume of step S702D1 with the corresponding virtual volume.

### Virtual Volume Clone Processing According to Fourth Embodiment

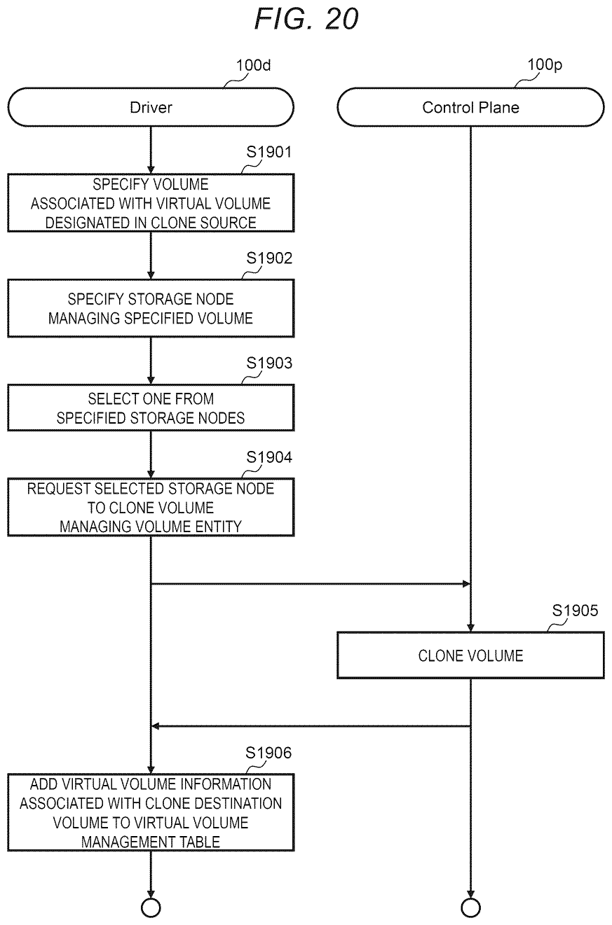

FIG. 20 is a sequence diagram illustrating virtual volume clone processing according to the fourth embodiment. A difference from the clone processing according to the second embodiment (FIG. 12) is that the driver 100d receives a clone request for a virtual volume and clones the virtual volume and a volume.

First, in step S1901, upon receiving a clone request for a virtual volume from the virtual machine platform 200p, the driver 100d refers to the virtual volume management table T5D (FIG. 18) and specifies a volume associated with the virtual volume.

Next, in step S1902, the driver 100d refers to the volume management table T2B (FIG. 10) and specifies the storage node 110 that manages the volume specified in step S1901.

Next, in step S1903, the driver 100d selects one of the storage nodes 110 specified in step S1902. Next, in step S1904, the driver 100d transmits a request to the control plane 100p so that the storage node 110 selected in step S1903 creates a clone of a volume having a volume entity.

Next, in step S1905, upon receiving the request transmitted in step S1904, the control plane 100p creates a clone of the volume. At this time, in the same storage node 110 as the volume entity associated with the volume designated as a clone source, a volume entity that is a clone of the volume entity is created. When the creation of the clone of the volume entity is completed, the control plane 100p transmits a completion notification to the driver 100d.

Next, in step S1906, the driver 100d creates information on the virtual volume associated with the volume of the clone destination, and adds the information to the virtual volume management table T5D (FIG. 18).

### Fifth Embodiment

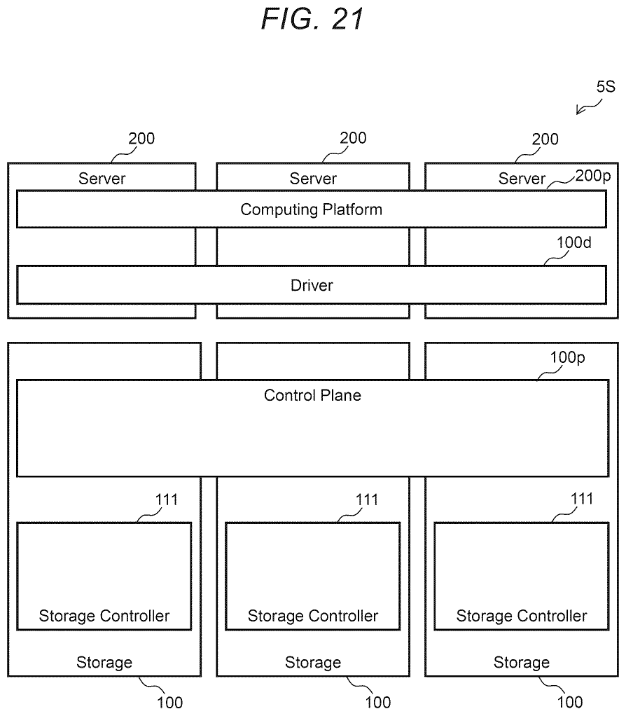

FIG. 21 is a diagram illustrating an outline of a fifth embodiment. In an information processing system 5S of the fifth embodiment, the driver 100d implemented in the storage 100 in the third embodiment and the fourth embodiment is implemented outside the storage 100. In the fifth embodiment, an example is illustrated in which the driver 100d is installed in the server 200. In the fifth embodiment, it is possible to perform distributed control such as distributing and arranging clones across the storage 100.

### Modification of Fifth Embodiment

In the fifth embodiment, the driver 100d existing outside the storage 100 controls a volume copy and a volume clone using the volume copy across the storage nodes 110 of the storage 100. However, the invention is not limited thereto, and the driver 100d may control the volume copy and the volume clone using the volume copy across the storages 100.

That is, the driver 100d replicates a clone source volume existing in a certain storage 100 to a different storage 100. Further, during clone creation of the clone source volume, the driver 100d selects one of the original clone source volume and its replicas, and requests the storage 100 that manages the selected volume to create a clone of the selected volume. A control algorithm at this time can be implemented by replacing the “storage node 110” with the “storage 100” in the control algorithm that controls the volume copy and the volume clone using the volume copy across the “storage node 110”.

Accordingly, it is possible to restrict an increase in communication for moving the clone source volume between the storages 100 and restrict a clone delay that is a waiting time for moving the clone source volume between the storages 100 in order to eliminate resource shortage.

### Storage Management Table T6 According to Fifth Embodiment

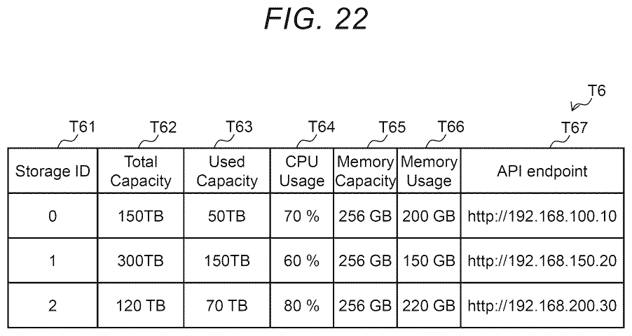

FIG. 22 illustrates a configuration of a storage management table T6 according to the fifth embodiment. The storage management table T6 is stored in the control information storage area R1 of the memory 111b.

The storage management table T6 according to the sixth embodiment manages the total capacity and the used capacity, the usage of the CPU (processor 111a), the total capacity and the used capacity of the memory 111b, and the API end point for each storage 100 identified by the storage ID T61. The driver 100d issues a request to the storage 100 based on the API end point T67.

### Sixth Embodiment

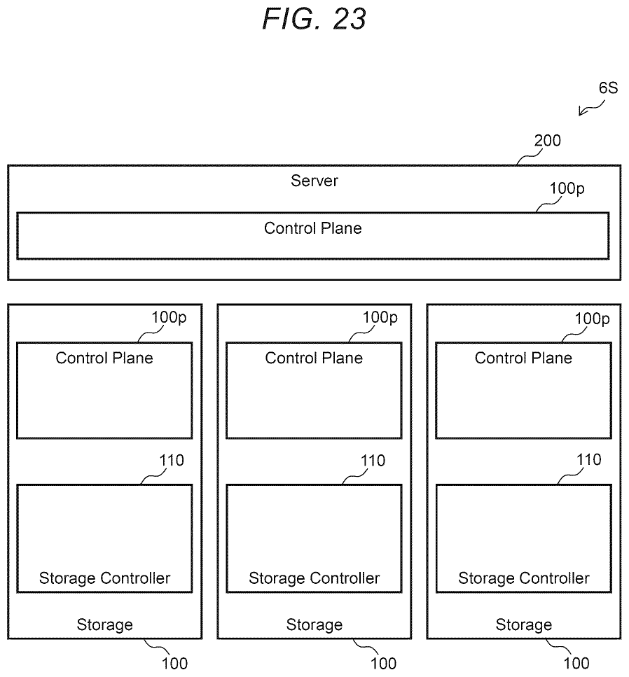

FIG. 23 is a diagram illustrating an outline of a sixth embodiment. In an information processing system 6S according to the sixth embodiment, the control plane 100p that controls a copy of a clone source volume and a clone using the copy across the storages 100 also operates in the server 200.

The control plane 100p existing outside the storage 100 includes, for example, management software that manages a plurality of storages 100. When creating a clone of a volume via such management software, the management software may control a copy of the clone source volume and clone creation using the copy.

That is, in the configuration of the information processing system 6S, the control plane 100p outside the storage 100 replicates a clone source volume existing in a certain storage to a different storage. Further, when cloning into the clone source volume, one of the original clone source volume and its replicas is selected, and creation of a clone of the selected volume is requested to the storage 100 that manages the selected volume. A control algorithm at this time can be implemented by replacing the “storage node 110” with the “storage 100” in the control algorithm that controls the volume copy and the volume clone using the volume copy across the “storage node 110”.

The control plane 100p executes control of receiving, from the external control plane 100p of the storage 100, a request for copying or cloning a volume in the storage 100 and instructing the storage controller 111 to perform copying or cloning.

Although not illustrated, the virtual machine platform 200p and the driver 100d may exist in the server 200. In this case, the control plane 100p, the virtual machine platform 200p, and the driver 100d may be implemented by the same server or may be implemented by different servers.

### Seventh Embodiment

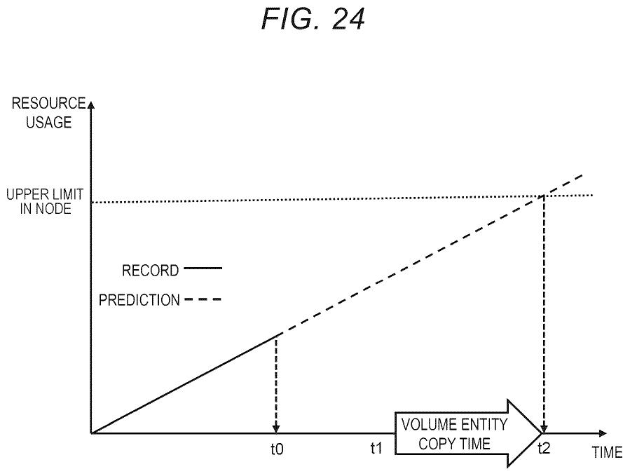

FIG. 24 is a graph illustrating an outline of a seventh embodiment. In the seventh embodiment, whether to create a replica of a volume entity (volume in the fourth embodiment and fifth embodiment) in the storage node 110 is dynamically determined based on a clone creation status.

The graph illustrated in FIG. 24 illustrates a temporal change in resource usage of the storage node 110, in which a solid line indicates a record value (current usage) and a dotted line indicates a predicted value (future usage) based on the record value. Here, t0 is a current time, and t2 is an upper limit reaching time at which the resource usage is predicted to reach an upper limit in a node. In addition, t1 is a final time among times at which copying should be started to complete replication of the volume entity VE1 by the upper limit reaching time t2.

The resource usage change is estimated by storing, as time-series information, resource usage held in a storage node management table T1E (FIG. 22) and performing regression analysis on the time-series information.

### Volume Entity Replication Processing According to Seventh Embodiment

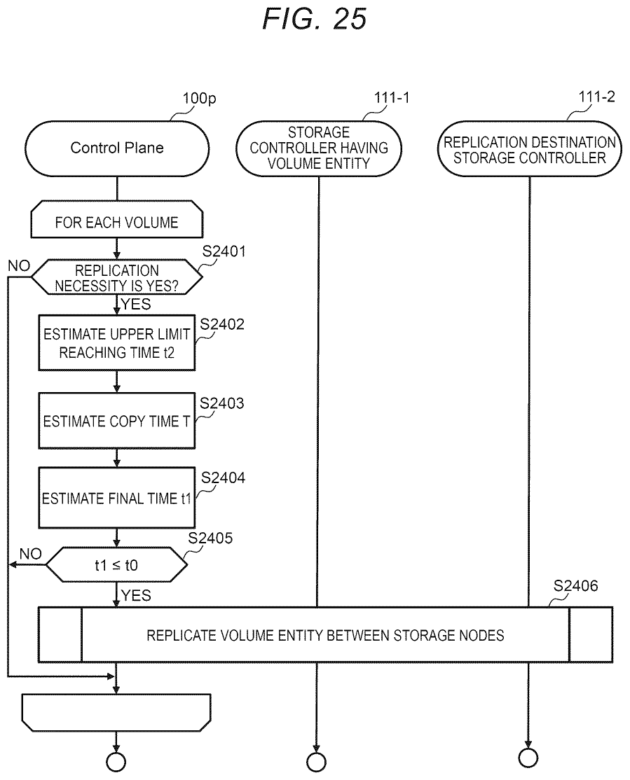

FIG. 25 is a flowchart illustrating volume entity replication processing according to the seventh embodiment.

Steps S2401 to S2406 are executed for all volumes.

First, in step S2401, the control plane 100p refers to the volume management table T2 (FIG. 6) and determines whether the replication necessity flag T24 of a currently selected volume is “YES”. When the replication necessity flag T24 is “YES” (YES in step S2401), the control plane 100p advances the processing to step S2402. On the other hand, when the replication necessity flag T24 is “NO” (NO in step S2401), the control plane 100p selects the next unselected volume and executes step S2401.

In step S2402, the control plane 100p estimates the upper limit reaching time t2. Next, in step S2403, the control plane 100p calculates a copy time T required for copying the volume entity by, for example, T=(size of volume entity VE1)÷(network bandwidth used for copying×w). Here, w is a multiplier of 1 or less. By setting w to less than 1, it is possible to secure a margin in the network bandwidth between the storage nodes 110 so as not to adversely affect other processing of the storage controller 111 when copying the volume entity VE1.

Next, in step S2404, the control plane 100p estimates the final time t1 based on the upper limit reaching time t2 estimated in step S2402 and the copy time T estimated in step S2403. The final time t1=t2−T (that is, the final time is a time earlier than the upper limit reaching time t2 by the copy time T). In a case of starting copying after reaching the final time t1, when a copy delay occurs due to disturbance or the like, the upper limit reaching time t2 is not met. In order to prevent this, when calculating the final time t1, the copy time T may be multiplied by a weight larger than 1 to give a margin to the time.

In step S2405, the control plane 100p determines whether t0 reaches t1 (t1≤t0).

The control plane 100p advances the processing to step S2406 when t1≤t0 (YES in step S2405), and selects the next unselected volume and executes step S2401 when t1>t0 (NO in step S2405).

In step S2406, the control plane 100p, the storage controller 111-1, and the storage controller 111-2 execute the same processing as the volume entity replication processing (FIG. 8) according to the first embodiment. The storage controller 111-1 is a storage controller having a replication source volume entity. The storage controller 111-2 is a storage controller having a replication destination volume entity. Step S2406 is executed synchronously or asynchronously with steps S2401 to S2405.

In the case of synchronous processing with steps S2401 to S2405, when step S2406 ends, the next unselected volume V1 is selected and step S2401 is executed. In the case of asynchronous processing with steps S2401 to S2405, when step S2406 ends, the volume entity replication processing of FIG. 25 ends.

When the driver 100d controls the replication processing as in the fourth embodiment and the fifth embodiment, the driver 100d is the execution subject of steps S2401 to S2405 instead of the control plane 100p in FIG. 25. Then, as illustrated in FIG. 19, a replication instruction is transmitted from the driver 100d to the control plane 100p, and replication is executed by the storage controllers 111-1 and 111-2.

### Effects of Seventh Embodiment

In the seventh embodiment, it is possible to create a clone source volume entity based on a result of determining, from current usage of resources of a plurality of storage nodes and future usage of the resources estimated from the current usage, whether to create the clone source volume entity.

### Eighth Embodiment

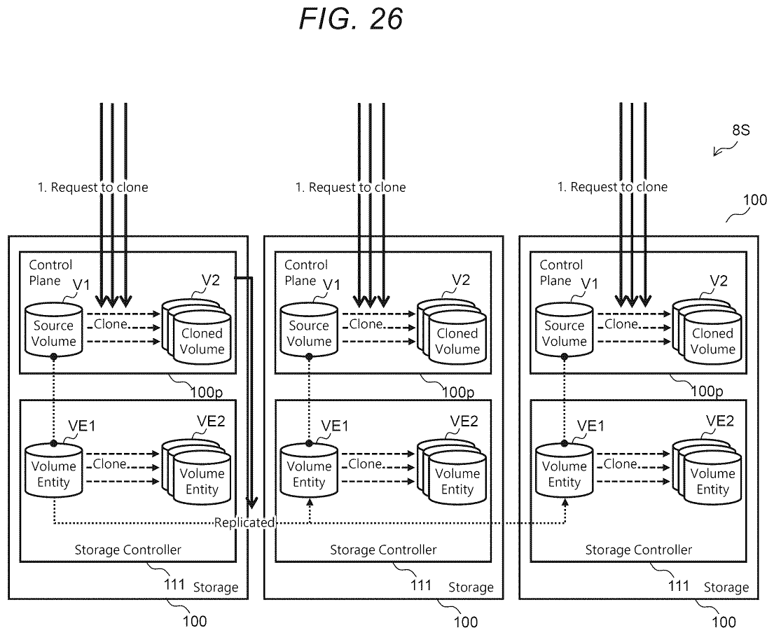

FIG. 26 is a diagram illustrating an outline of an eighth embodiment. In an information processing system 8S according to the eighth embodiment, a clone source volume is replicated across the storages 100, and each storage 100 individually manages clones from the replication destination volume V2 and the clone source volume V1.

Similarly to other embodiments, the clone source volume V1 existing in a certain storage 100 is replicated in another storage 100. The replication processing is cooperatively controlled by the control planes 100p of the replication source and replication destination storages 100, and replication is instructed to the storage controller 111 of each storage 100.

In the configuration of the eighth embodiment, the control plane 100p performs control up to processing of copying the clone source volume V1 to another storage 100. On the other hand, the clone source volume V1 and the replication destination volume V2 are individually managed in each storage 100. Therefore, after the clone source volume V1 is replicated, the clone operation based on the volume V1 and the clone destination volume V2 is individually requested and executed in the control plane 100p of each storage 100.

Although not illustrated, the driver 100d may be implemented on the server 200, and the driver 100d may request each storage 100 to perform the clone creation.

Although some embodiments have been described above, these embodiments are examples for describing the invention, and the scope of the invention is not limited to these embodiments. The invention can be implemented in various other forms, for example, a form in which a part of the configuration of each of the above-described embodiments is deleted, a form in which at least a part of the configuration is replaced, a form in which a configuration is added, and a form in which a part or all of the embodiments are combined.

What is claimed is:

1. A clone creation method for a storage system including a plurality of storage nodes each including a processor, a memory, and a drive, the clone creation method comprising processors of the plurality of storage nodes performing processing of:
providing a volume for a server;
creating, in a storage node, a volume entity that is created in associated with a storage area of the drive and stores data input to the volume;
when a creation request for a clone volume of the volume is received, creating, in any storage node, a clone volume entity that is associated with the clone volume and is for accessing data in a storage device related to the volume entity;
creating a plurality of volume entities in a plurality of storage nodes, and storing the data in storage areas of different drives; and
selecting a storage node, which creates the clone volume entity, and a volume entity related to an access destination of the clone volume entity when a creation request for the clone volume is received.

2. The clone creation method according to claim 1, wherein
the processor
selects the storage node for creating the volume entity based on at least one of usage of resources of the plurality of storage nodes, a setting condition of a path related to access to each of the storage nodes, and an assumed number of clones to be created in each of the storage nodes.

3. The clone creation method according to claim 1, further comprising:
creating the clone volume entity in a storage node having the volume entity, wherein
the processor
selects a storage node for creating the clone volume entity based on at least one of usage of resources of a storage node having the volume entity, a setting condition of a path related to access to each of the storage nodes, and location information on a location of the storage node.

4. The clone creation method according to claim 1, wherein
necessity of creating a plurality of volume entities is set for the volume.

5. The clone creation method according to claim 4, wherein
the processor
sets the necessity of creating a plurality of volume entities for the volume based on a predetermined condition related to the volume.

6. The clone creation method according to claim 5, wherein
the predetermined condition is the number of clone volumes to be created.

7. The clone creation method according to claim 3, further comprising the processor performing processing of:
estimating an upper limit reaching time, at which usage of resources of the plurality of storage nodes reaches an upper limit of the usage of the resources, based on the usage of the resources;
estimating a replication time required for replication of the volume entity between the plurality of storage nodes;
determining whether to create a replica of the volume entity between the plurality of storage nodes based on estimation results of the upper limit reaching time and the replication time; and
creating the volume entity when it is determined to create a replica of the volume entity.

8. The clone creation method according to claim 4, wherein
the processor
sets the necessity of creating a plurality of volume entities based on an attribute of computer resources using the volume.

9. A storage system comprising:
a plurality of storage nodes each including a processor, a memory, and a drive, wherein
processors of the plurality of storage nodes
provide a volume for a server,
create, in a storage node, a volume entity that is created in associated with a storage area of the drive and stores data input to the volume,
when a creation request for a clone volume of the volume is received, create, in any storage node, a clone volume entity that is associated with the clone volume and is for accessing data in a storage device related to the volume entity,
create a plurality of volume entities in a plurality of storage nodes, and store the data in storage areas of different drives, and
select a storage node, which creates the clone volume entity, and a volume entity related to an access destination of the clone volume entity when a creation request for the clone volume is received.
